(19) United States
(12) Patent Application Publication
(10) Pub. No.: US 2015/0308387 A1
(43) Pub. Date: Oct. 29, 2015

(54) GAS HEAT EXCHANGER, IN PARTICULAR FOR EXHAUST GASES OF AN ENGINE

(71) Applicant: VALEO TERMICO, S.A., Zaragoza (ES)

(72) Inventors: Inigo Tolosa Echarri, Zaragoza (ES); Rosa Puertolas Rebollar, Zaragoza (ES); Juan Carlos De Francisco Moreno, Zaragoza (ES); Dario Pena Sanchez, Zaragoza (ES)

(73) Assignee: VALEO TERMICO, S.A., Zaragoza (ES)

(21) Appl. No.: 14/648,033

(22) PCT Filed: Nov. 22, 2013
(86) PCT No.: PCT/EP2013/074480

§ 371 Date: May 28, 2015

(30) Foreign Application Priority Data
Nov. 28, 2012 (ES) P201231852

(51) Int. Cl. F02M 25/07; F28D 7/16

(52) U.S. Cl. CPC F02M 25/0734; F28D 7/163

(57) ABSTRACT

A gas heat exchanger for the exhaust gases of an engine including a plurality of parallel tubes that are arranged inside a casing and through which flow the gases to be cooled by heat exchange with a coolant, the coolant inlet and outlet conduits being each arranged at an opposing extremity of the casing on a single side of said casing, is disclosed. Each tube has a protuberance opposing the direction of the gases, it being possible to assemble said tubes by stacking them such that the protuberances of the respective tubes form a barrier, in the form of a deflector, intended to create a predetermined pathway guaranteeing an appropriate distribution of the coolant flow from the inlet of same to the outlet of same about the tubes and along the entire length of the exchanger. The distribution of the coolant flow passing through same is improved without the need for conventional deflectors.

The present invention relates to a gas heat exchanger, in particular for exhaust gases of an engine. The invention relates specifically to exhaust gas recirculation (EGRC) heat exchangers of an engine.

### BACKGROUND OF THE INVENTION

In certain heat exchangers for cooling gas, for example those used in exhaust gas recirculation systems to the inlet of an internal combustion engine, the two environments exchanging heat are separated by a wall.

The EGR exchangers currently available on the market are metal heat exchangers usually made of stainless steel or aluminum.

There are essentially two types of EGR heat exchanger: the first comprises a casing containing a set of parallel tubes for conveying the gases, the coolant flowing inside the casing and outside the tubes, and the second type comprising a series of parallel plates that form the heat exchange surfaces such that the exhaust gases and the coolant flow between two plates, in alternating layers, with the option of including fins to improve heat exchange.

In the case of tube-set heat exchangers, the tubes and the casing may be assembled together in different ways. In general, the tubes are attached by the extremities of same between two supporting plates connected at each extremity of the casing, the two supporting plates having a plurality of orifices for installation of the respective tubes.

Said supporting plates are attached in turn to means for attachment to the recirculation line, which may be a V assembly or a peripheral connecting collar or flange, depending on the design of the recirculation line in which the exchange is assembled. The peripheral collar may be assembled with a gas tank, such that the gas tank is an intermediate part between the casing and the collar, or the collar may be assembled directly on the casing.

In both types of EGR exchanger, most of the components of same are metallic, such that they are assembled by mechanical means and then oven, arc or laser welded to ensure the seal required for this application. In some cases, they may also include some plastic components, which may have a single function or several functions incorporated into a single part.

One of the conditions to be satisfied by EGR heat exchangers is maintaining an appropriate distribution of the coolant flow to ensure good efficiency and sufficient durability. If the distribution of the coolant flow is inadequate, the level of efficiency may drop, resulting in boiling and affecting the durability of the heat exchanger under the effect of thermal fatigue.

The distribution of the coolant flow depends essentially on the placement of the coolant inlet and outlet conduits. A general recommendation is that the coolant outlet conduit should be positioned in the upper portion of the exchanger, while the coolant inlet conduit should be positioned conversely in the lower portion of the exchanger, with distribution of the coolant fluid improving as the distance between the coolant inlet and outlet conduits increases.

Sometimes, the design of the layout of the coolant circuit of the engine does not enable the aforementioned recommendations to be simply observed. In this case, additional deflectors need to be used to ensure that the coolant flow reaches all of the internal space of the heat exchanger. Moreover, the use of deflectors increases the price of the exchanger and makes the assembly process more complex, which means that significant investment is required to assemble the deflector.

Patents JP2000292089 and JP2000283666 describe tube-set heat exchangers that include a plurality of transverse deflectors in the form of plates arranged inside a housing of circular section. The design of said deflectors greatly resembles the layout of the supporting plates located at the two extremities of the casing. The diameter of these deflectors is equal to the internal diameter of the casing and they include openings to enable the coolant to pass through. The positions of said through-openings in the different deflectors are arranged alternately.

Patent KR20080013457 describes a tube-set heat exchanger that includes a helical deflector inserted along the casing of circular section.

Patent US2005161206 A1 describes a heat exchanger with stacked plates in which the coolant inlet and outlet conduits are located at opposing extremities, but on the same side face of the casing. Each plate has a transverse protuberance pressed into a lateral coolant inlet zone, as well as a plurality of shorter protuberances pressed along the plate, which are able to distribute the coolant from the lateral inlet zone of same across the entire surface of the plates.

Patent US2008169093 A1 describes a heat exchanger with stacked plates in which the coolant inlet and outlet conduits are located at opposing extremities and on opposing faces of the casing of the exchanger. Each plate has a transverse protuberance pressed into a lateral coolant inlet zone, as well as a plurality of shorter protuberances pressed along the plate, which are able to distribute the coolant from the lateral inlet zone of same across the entire surface of the plates.

However, tube-set heat exchangers in which the tubes have protuberances arranged transverse to the direction of the gases to improve the distribution of the coolant, which is desirable, are not known.

### Description of the Invention

The purpose of the gas heat exchanger, in particular for the exhaust gases of an engine, according to the present invention, is to overcome the drawbacks in the exchangers known in the prior art by proposing a heat exchanger that improves the distribution of the coolant flowing through same, without the need to use deflectors.

The gas heat exchanger, in particular for the exhaust gases of an engine, according to the present invention, includes a plurality of parallel tubes that are arranged inside a casing and through which flow the gases to be cooled by heat exchange with a coolant, and in which the coolant inlet and outlet conduits are each arranged at an opposing extremity of the casing, preferably on a single side of said casing. It is characterized in that each tube has a protuberance opposing the direction of the gases, it being possible to assemble said tubes by stacking same on one another such that the protuberances of the respective tubes form a barrier, in the form of a deflector, intended to create a predetermined pathway guaranteeing an appropriate distribution of the coolant flow from the inlet of same to the outlet of same about the tubes and along the entire length of the exchanger.

The use of protuberances on the tubes obviates the need to use deflectors such as those known in the prior art. Accordingly, appropriately orienting the protuberance of each tube during the tube-set assembly process creates a barrier that acts as a deflector that is able to direct the coolant flow through the inside of the heat exchanger, thereby improving the distribution of said coolant flow.

The aforementioned deflector effect is achieved by contact between the protuberances of the respective tubes, such that the barrier or deflector obtained forces the coolant to flow along a pathway able to ensure good distribution of the coolant.

On account of this deflector effect, the turbulence created in all directions and the improved pathway from the inlet to the outlet of the coolant improve the cooling of the tube set. It should be noted that, without this deflector effect, the coolant would flow directly from the inlet to the outlet, without flowing about the tubes, which is not desirable.

Preferably, the parallel tubes have a substantially rectangular section, each tube having a protuberance transverse to the direction of the gases, such that said transverse protuberances of the respective tubes form a substantially vertical transverse barrier.

According to one embodiment of the invention, the tubes are oriented such that the respective transverse protuberances of the top half of the tube set are located at a distance of approximately one third of the length of the tube from the gas inlet, thereby forming a first vertical transverse barrier, while the respective transverse protuberances of the bottom half of the tube set are located at a distance of approximately two thirds of the length of the tube from the gas inlet, thereby, forming a second vertical transverse barrier, such that the two transverse barriers form a Z-shaped pathway for the coolant flow, the coolant inlet conduit being located in the upper portion at one extremity of a side face of the casing, upstream of said first transverse barrier, and the coolant outlet conduit being located in the lower portion of the opposing extremity of the same side face of the casing, downstream of said second transverse barrier.

This solution is particularly advantageous if the coolant enters and leaves the exchanger, on the same side of the casing.

The transverse barriers or deflectors created force the coolant flow to fill the inside of the exchanger in all directions, but with an appropriate distribution of the coolant flow from the coolant inlet to the coolant outlet, thereby preventing the coolant from flowing directly from the inlet to the outlet of same. Furthermore, the flow generated inside the casing is Z-shaped, which differs completely from the coolant flow pathways in the stacked-plate exchangers in the prior art that use a transverse protuberance.

According to one embodiment, each tube has just one transverse protuberance located on one of the faces of same.

According to another embodiment, each tube has two transverse protuberances located on opposing faces of the tube.

Advantageously, each tube has a plurality of projections, preferably of circular section, that are distributed along the tube and used for support and assembly with adjacent tubes, which in turn delimit a predetermined space between the tubes for the coolant to pass through.

### SHORT DESCRIPTION OF THE DRAWINGS

The attached drawings are provided to facilitate the description of the foregoing, and they show, schematically and purely by way of nonlimiting example, a practical example embodiment of the gas heat exchanger, in particular for exhaust gases of an engine, according to the invention, in which:

FIG. 1 is a perspective view of the heat exchanger according to the present invention, showing the casing with the tube set and the coolant inlet and outlet conduits,

FIG. 2 is a perspective view of a tube showing the transverse protuberance and the support projections,

FIG. 3 is a side view of a tube with a single transverse protuberance, according to one embodiment of the invention,

FIG. 4 is a side view of the tube with two transverse protuberances arranged on opposing faces, according to another embodiment of the invention,

FIG. 5 is a perspective view of the heat exchanger in FIG. 1, showing a longitudinal cutting plane T, and

FIG. 6 is a longitudinal cross section of the heat exchanger along the cutting plane T shown in FIG. 5.

### DETAILED DESCRIPTION OF A PREFERRED EMBODIMENT

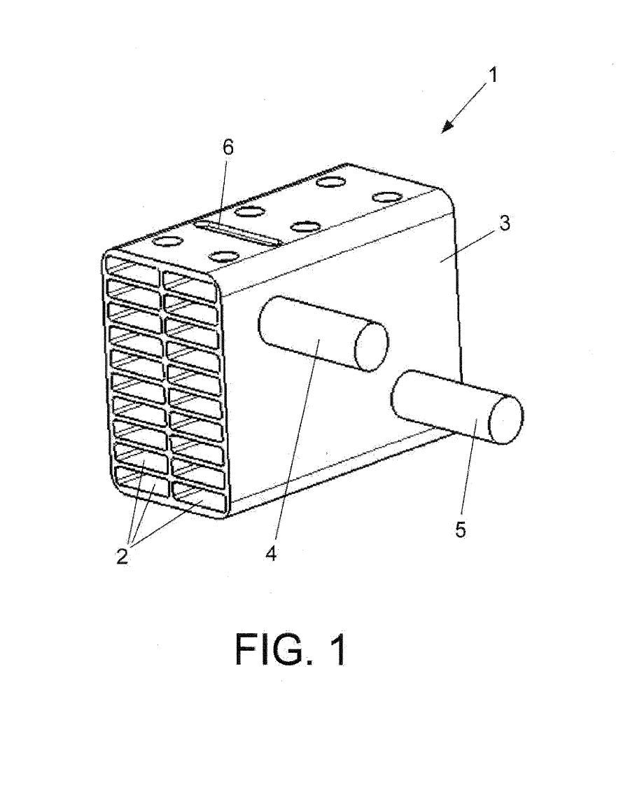

With reference to FIG. 1, the gas heat exchanger 1, in particular for exhaust gases of an engine, according to the present invention includes a plurality of parallel tubes 2 having a substantially rectangular section, arranged inside a housing 3, through which flow the gases to be cooled by heat exchange with a coolant. It also has a coolant inlet conduit 4 and a coolant outlet conduit 5 arranged at opposing extremities and on a single side of said casing 3.

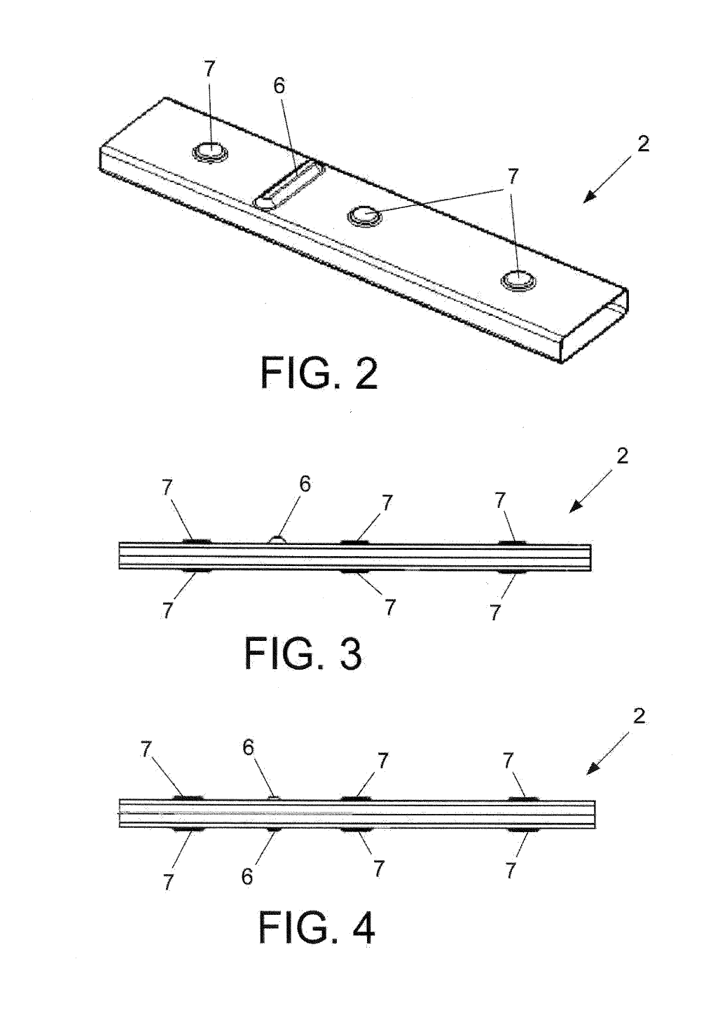

As shown in FIG. 2, each tube 2 has a protuberance 6 transverse to the gas direction that is located at a distance of approximately one third of the length of the tube from one of the extremities of same.

The tubes 2 may have a single transverse protuberance 6 located on one of the faces of same (see FIG. 3) or they may have two transverse protuberances 6 located on opposing faces of the tube 2 (see FIG. 4).

Each tube 2 has a plurality of projections 7 of circular section that are distributed along the tube 2 and used for support and assembly with adjacent tubes 2, which in turn delimit a predetermined space between the tubes 2 for the coolant to pass through.

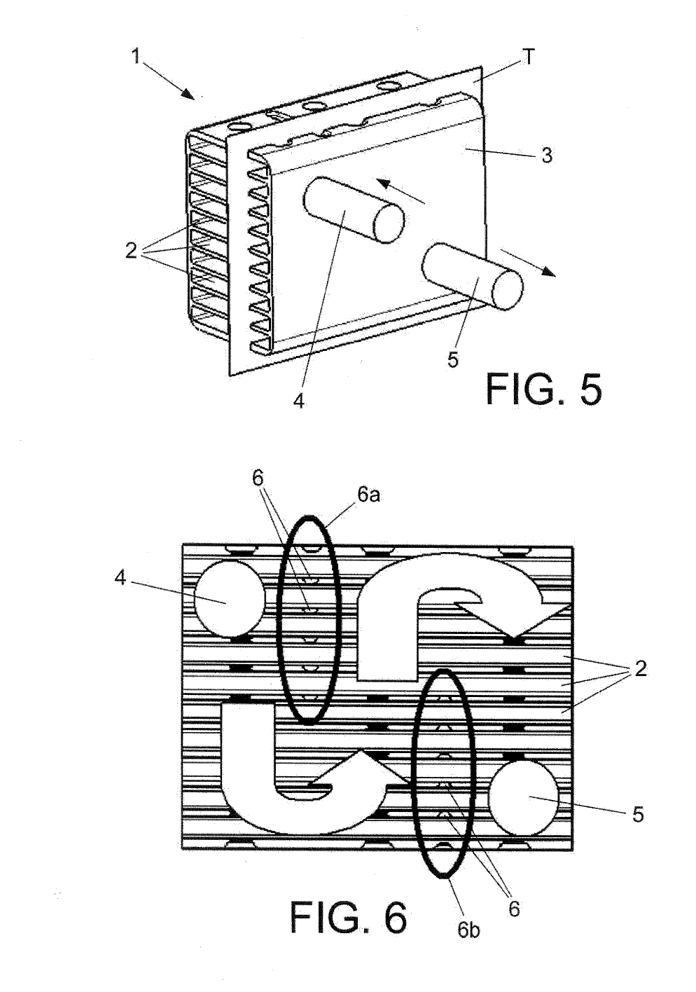

FIG. 6 shows a longitudinal cross section of the heat exchanger 1 along the cutting plane T shown in FIG. 5. In this case, the tubes 2 are assembled by stacking same on one another and orienting same such that the respective transverse protuberances 6 of the top half of the set of tubes 2 are located at a distance of approximately one third of the length of the tube 2 from the gas inlet, thereby forming a first vertical transverse barrier 6a, while the respective transverse protuberances 6 of the bottom half of the set of tubes 2 are located at a distance of approximately two thirds of the length of the tube 2 from the gas inlet, thereby forming a second vertical transverse barrier 6b. As such, the two transverse barriers 6a and 6b form a Z-shaped pathway for the coolant flow, as shown by the arrows in FIG. 6.

In this case, the coolant inlet conduit 4 is located in the upper portion at one extremity of a side face of the casing 3, upstream of said first transverse barrier 6a, while the coolant outlet conduit 5 is located in the lower portion of the opposing extremity of the same side face of the casing 3, downstream of said second transverse barrier 6b.

The aforementioned deflector effect is achieved by contact between the transverse protuberances 6 of the respective tubes 2, such that the transverse barriers or deflectors 6a and 6b created force the coolant flow to fill the inside of the exchanger 1 in all directions, but with an appropriate distribution of the coolant flow from the coolant inlet 4 to the coolant outlet 5, thereby preventing the coolant from flowing directly from the inlet to the outlet of same. Furthermore, the flow generated inside the casing is Z-shaped, which differs completely from the coolant flow pathways in the stacked-plate exchangers in the prior art that use a transverse protuberance.

Although reference is made to a specific embodiment of the invention, it is obvious for a person skilled in the art that the gas heat exchanger, in particular for exhaust gases of an engine, described here is susceptible of numerous variants and modifications, and that all of the details mentioned can be replaced with other, technically equivalent details without thereby moving outside the scope of the protection defined by the attached claims.

1. A gas heat exchanger for the exhaust gases of an engine, comprising:
a plurality of parallel tubes arranged inside a casing and through which flow the gases to be cooled by heat exchange with a coolant, and in which the coolant inlet and outlet conduits are each arranged at an opposing extremity of the casing on a single side of said casing,
wherein each tube has a protuberance opposing the direction of the gases, wherein said tubes are assembled by stacking the tubes such that the protuberances of the respective tubes form a barrier, in the form of a deflector, intended to create a predetermined pathway guaranteeing an appropriate distribution of the coolant flow from the inlet of same to the outlet of same about the tubes and along the entire length of the exchanger.

2. The exchanger as claimed in claim 1, wherein the parallel tubes have a substantially rectangular section, each tube having a protuberance transverse to the direction of the gases, such that said transverse protuberances of the respective tubes form a substantially vertical transverse barrier.

3. The exchanger as claimed in claim 2, wherein the tubes are oriented such that the respective transverse protuberances of the top half of the set of tubes are located at a distance of approximately one third of the length of the tube from the gas inlet, thereby forming a first vertical transverse barrier, while the respective transverse protuberances of the bottom half of the set of tubes are located at a distance of approximately two thirds of the length of the tube from the gas inlet, thereby forming a second vertical transverse barrier, such that the two transverse barriers form a Z-shaped pathway for the coolant flow, the coolant inlet conduit being located in the upper portion at one extremity of a side face of the casing, upstream of said first transverse barrier, and the coolant outlet conduit being located in the lower portion of the opposing extremity of the same side face of the casing, downstream of said second transverse barrier.

4. The exchanger as claimed in claim 2, wherein each tube has just one transverse protuberance located on one of the faces of same.

5. The exchanger as claimed in claim 2, wherein each tube has two transverse protuberances located on opposing faces of the tube.

6. The exchanger as claimed in claim 1, wherein each tube has a plurality of projections of circular section, that are distributed along the tube and used to support and assemble adjacent tubes on one another, said tubes in turn delimiting a predetermined space between the tubes for the coolant to pass through.
